(19) United States
(12) Patent Application Publication
(10) Pub. No.: US 2026/0017764 A1
(43) Pub. Date: Jan. 15, 2026

(54) DENOISING MEDICAL IMAGING DATA

(71) Applicant: Siemens Healthineers AG, Forchheim (DE)

(72) Inventors: Philipp Roser, Allston, MA (US); Christopher Syben, Cadolzburg (DE)

(21) Appl. No.: 19/266,920

(22) Filed: Jul. 11, 2025

(30) Foreign Application Priority Data
Jul. 11, 2024 (EP) 24188034

(51) Int. Cl. G06T 5/70; G06T 5/10

(52) U.S. Cl. CPC G06T 5/70; G06T 5/10; G06T 2207/10116; G06T 2207/20056; G06T 2207/20064; G06T 2207/20081; G06T 2207/20084; G06T 2207/30004

(57) ABSTRACT

For denoising medical imaging data, a first imaging dataset and a second imaging dataset are decomposed according to spatial frequency bands to generate high-frequency datasets corresponding to a high-frequency band and low-frequency datasets corresponding to a low-frequency band. A trainable denoising algorithm is trained by carrying out an optimization that uses at least one parameter of the denoising algorithm as an optimization variable and an objective function that depends on a denoised high-frequency dataset and the high-frequency dataset of the second imaging dataset. The denoised high-frequency dataset is generated by applying the denoising algorithm to the high-frequency dataset of the first imaging dataset. The trained denoising algorithm is applied to the high-frequency dataset of the first imaging dataset to generate a final denoised high-frequency dataset.

This application claims the benefit of European Patent Application No. EP 24188034, filed on Jul. 11, 2024, which is hereby incorporated by reference in its entirety.

### BACKGROUND

The present embodiments are directed to denoising medical imaging data.

In spectral X-ray imaging, spectral computed tomography (CT) or spectral cone beam CT (CBCT), the same scene is, for example, acquired with different X-ray spectra to separate otherwise ambiguous materials. Since the same scene is acquired multiple times, simultaneously or sequentially, the total applied dose is proportionally higher as compared to a conventional X-ray or CT procedure. To mitigate excess doses, the doses of individual acquisitions may be lowered such that the total dose is not significantly higher than the standard dose of a monoenergetic acquisition. This, in turn, increases the amount of noise in the medical imaging data. The noise may be further amplified when material decomposition methods are employed. Further, one may use multi-layer detectors. The noise in such detectors increases with increasing depth.

As a consequence, rather strong denoising may be applied. This is, in general, a difficult task, as it is always a trade-off between noise suppression and preservation of fine potentially relevant details. An established class of denoising algorithms corresponds to bilateral filters (e.g., joint bilateral filters) that are used in most clinical systems. It is, however, time-consuming and may yield artifacts or intensity drifts. Guided filtering potentially is faster than bilateral filtering but is not widely adopted. Guided filtering relies on a guidance image having an impact that is not well foreseeable.

Similar situations may arise also in the context of other medical imaging devices such as magnetic resonance imaging (MRI). There, the noise may, for example, be increased when using MRI sequences with short acquisition times.

These drawbacks may, for example, be overcome at least partially by using trained machine learning models (MLMs) (e.g., artificial neural networks (ANNs) for denoising). For example, denoising ANNs such as the Noise2Noise proposed in the publication J. Lehtinen et al.: “Noise2Noise: Learning Image Restoration without Clean Data” (arXiv:1803.04189) or ANNs based on the U-Net architecture as introduced in the publication by O. Ronneberger et al.: “U-Net: Convolutional Networks for Biomedical Image Segmentation” (arXiv:1505.04597), work well but rely on matching training pairs that are difficult to acquire, especially in the field of medical imaging.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved concept for denoising medical imaging data is provided. For example, two imaging datasets acquired with different imaging parameters are provided, which allows for an effective denoising without losing potentially relevant details but also without requiring training images and correspondingly annotated ground truth images.

The present embodiments are based on the insight that, in a hypothetical ideal situation without noise, medical imaging data acquired with different imaging parameters may have the same or very similar structural information (e.g., information in high spatial frequency ranges), but differ in their intensity or low spatial frequency information. In non-ideal situations (e.g., in realistic situations with noise), the contents of the medical imaging data acquired with different imaging parameters differ in the specific manifestations of the noise also in the high-frequency range. Thus, according to the present embodiments, a frequency decomposition of the imaging datasets is carried out, and an optimization of a trainable denoising algorithm is carried out. An objective function depends on a denoised high-frequency dataset based on high-frequency content of the first imaging dataset and the high-frequency content of the second imaging dataset.

According to an aspect of the present embodiments, a computer-implemented method for denoising medical imaging data is provided. Therein, a first imaging dataset generated according to a first imaging parameter set and depicting an object and a second imaging dataset generated according to a second imaging parameter set depicting the object are received. The first imaging dataset and the second imaging dataset are decomposed according to two or more spatial frequency bands. The decomposition includes generating a high-frequency dataset of the first imaging dataset and a high-frequency dataset of the second imaging dataset corresponding to a high-frequency band of the two or more spatial frequency bands. The decomposition also includes generating a low-frequency dataset of the first imaging dataset and a low-frequency dataset of the second imaging dataset corresponding to a low-frequency band of the two or more spatial frequency bands. A trainable denoising algorithm is trained by carrying out an optimization that uses at least one parameter of the denoising algorithm as at least one parameter optimization variable and an objective function. The objective function depends on a denoised high-frequency dataset and the high-frequency dataset of the second imaging dataset. Therein, the denoised high-frequency dataset is generated by applying the denoising algorithm to the high-frequency dataset of the first imaging dataset. The trained denoising algorithm is applied to the high-frequency dataset of the first imaging dataset to generate a final denoised high-frequency dataset.

Unless stated otherwise, all acts of the computer-implemented method may be performed by a data processing system that includes at least one data processing device. For example, the at least one data processing device is configured or adapted to perform the acts of the computer-implemented method. For this purpose, the at least one data processing device may, for example, store a computer program including instructions that, when executed by the at least one data processing device, cause the at least one data processing device to execute the computer-implemented method. The expressions “data processing system” and “at least one data processing device” may be used interchangeably, here and in the following. This holds also for respective expressions derived therefrom.

In case the at least one data processing device includes two or more data processing devices, certain acts carried out by the at least one data processing device may also be understood such that different data processing devices carry out different acts or different parts of an act. For example, it is not required that each data processing device carries out the acts completely. In other words, carrying out the acts may be distributed amongst the two or more data processing devices.

From each implementation of the computer-implemented method, a respective implementation of a method for denoising medical imaging data, which is not purely computer-implemented, is obtained by including respective acts of generating the first imaging dataset and the second imaging dataset (e.g., by a medical imaging device).

For example, the medical imaging data includes or consists of the first imaging dataset and the second imaging dataset. The final denoised high-frequency dataset may be considered as a result of the computer-implemented method. The final denoised high-frequency dataset may, for example, be recombined with the low-frequency dataset of the first imaging dataset or a final denoised low-frequency dataset of the first imaging dataset to generate a recombined first imaging dataset. It is also possible that a final denoised high-frequency dataset of the second imaging dataset is generated. The final denoised high-frequency dataset of the second imaging dataset may, for example, be recombined with the low-frequency dataset of the second imaging dataset or a final denoised low-frequency dataset of the second imaging dataset to generate a recombined second imaging dataset. It is noted, however, that the denoising may not be mandatory for the low-frequency datasets, since the noise may be significant only in high-frequency datasets. The recombined first imaging dataset and/or the recombined second imaging dataset may, for example, be used as a basis for medical analysis of the depicted object. The recombination steps and/or steps for generating the final denoised low-frequency datasets of the first imaging dataset and/or the first imaging dataset and/or steps for generating the final denoised high-frequency dataset of the second imaging dataset are not necessarily part of the computer-implemented method according to the present embodiments but may be part of the computer-implemented method in some embodiments.

An imaging dataset may, for example, be a two-dimensional image (e.g., X-ray image or MRI image) or a three-dimensional volume reconstruction (e.g., CBCT reconstruction, CT reconstruction, or MRI reconstruction). An imaging dataset may also be a two-dimensional patch of such a two-dimensional image or a three-dimensional volume part of such a three-dimensional volume reconstruction. A CBCT reconstruction or CT reconstruction may also be denoted as X-ray-based image reconstruction.

An imaging parameter set includes one or more imaging or acquisition parameters. If the first imaging dataset and the second imaging dataset have been generated by an X-ray device or a CT device or a CBCT device, the respective imaging parameter sets may, for example, include one or more parameters affecting or defining an X-ray spectrum emitted by an X-ray source of the device for generating the respective imaging dataset (e.g., a peak kilovoltage, kVp, a tube current, a filter material, and/or filter thickness of an X-ray filter), a parameter specifying whether an anti-scattering grid is used or not, a property of the anti-scattering grid, or a parameter of an X-ray detector of the device, such as a gain factor. In case of a photon-counting CT device, the respective imaging parameter sets may also include an energy threshold of the X-ray detector, etc. In case of an MRI device, the respective imaging parameter sets may, for example, include one or more parameters affecting or defining an acquisition time used for generating the respective imaging dataset.

The first imaging parameter set differs from the second imaging parameter set. In other words, at least one parameter value of the first imaging parameter set differs from the respective parameter values of the second imaging parameter set. Consequently, in case of an X-ray device or a CT device or a CBCT device, the first imaging dataset and the second imaging dataset correspond to different emitted and/or detected X-ray, etc. In case of an MRI device, the first imaging dataset and the second imaging dataset correspond to different acquisition times. Apart from that, the first imaging dataset and the second imaging dataset depict the same or approximately the same part of the object from the same or approximately the same perspective, if applicable.

The decomposition may be carried out separately for the first imaging dataset and the second imaging dataset. Known methods for frequency decomposition may be used for this purpose, including, for example, a Fourier decomposition, a wavelet decomposition, and so forth. A result of the decomposition of the first imaging dataset includes the high-frequency dataset of the first imaging dataset and the low-frequency dataset of the first imaging dataset. The high-frequency band corresponds to higher spatial frequencies than the low-frequency band. It is possible that the decomposition is done according to only these two frequency bands. It is possible, however, that the two or more spatial frequency bands include one or more additional frequency bands. In general, the decomposition yields one respective frequency-specific imaging dataset for each frequency band of the two or more spatial frequency bands. These explanations hold analogously for the decomposition of the second imaging dataset.

Each frequency-specific imaging dataset is given in the image domain or position domain just as the first imaging dataset and the second imaging dataset. For example, the decomposition may include a transformation into the frequency domain (e.g., using a Fourier transform or the like), a separation of the transformed imaging dataset according to the two or more spatial frequency bands, and an inverse transformation of the resulting separated frequency data in the image domain.

The objective function, which may also be denoted as loss function, may comprise one or more terms, which may, for example, be combined (e.g., by a weighted summation) to form the objective function. One of the one or more terms depends on the denoised high-frequency dataset and the high-frequency dataset of the second imaging dataset (e.g., a deviation between the denoised high-frequency dataset and the high-frequency dataset of the second imaging dataset). The deviation may, for example, be quantified as an L1-norm or an L2-norm or another suitable measure.

It is noted that the denoising algorithm is not or at least not necessarily pre-trained. For example, it is not necessary that the denoising algorithm is trained based on any training images before it is trained implicitly or inherently for denoising the high-frequency dataset of the first imaging dataset within the computer-implemented method according to the present embodiments. In other words, the training phase and the application phase of the denoising algorithm are not separated. Consequently, the denoising algorithm is trained again each time the computer-implemented method is carried out.

The optimization is, for example, carried out iteratively in two or more iterations including an initial iteration and a final iteration. For each iteration, a respective current value for the optimization variables (e.g., for the at least one parameter of the denoising algorithm) is set. The resulting current version of the denoising algorithm is applied to the high-frequency dataset of the first imaging dataset, and the objective function is evaluated accordingly. For the next iteration, the respective values for the optimization variables may be varied or set based on a result of the evaluated objective function. The number of the two or more iterations may be predefined. Alternatively, it may be determined in each iteration whether the result of the evaluated objective function fulfills a predefined termination criterion. The iterations are then carried out until the termination criterion is fulfilled. The trained denoising algorithm corresponds to the denoising algorithm with the at least one parameter of the denoising algorithm as defined in the final iteration of the two or more iterations. Consequently, the final denoised high-frequency dataset corresponds, for example, to the denoising algorithm used in the final iteration.

According to a number of (e.g., several) embodiments, the optimization includes generating (e.g., in each of the iterations or during a subset of the iterations) a first recombined dataset based on the low-frequency dataset of the first imaging dataset and the denoised high-frequency dataset. The objective function depends on the first recombined dataset and the first imaging dataset.

For example, the first recombined dataset may be computed based on the non-denoised low-frequency dataset of the first imaging dataset. For example, a second term of the one or more terms of the objective function depends on the first recombined dataset and the first imaging dataset (e.g., a deviation between the first recombined dataset and the first imaging dataset). The second term may, for example, be a content-based or content-sensitive loss term, a VGG-loss term, a structural similarity index, SSIM, loss term, a multiscale SSIM, MSSIM, loss term, or a mean-squared error loss term, for example.

In such embodiments, the second term of the objective function provides that the general image impression and intensity after the denoising is not fundamentally different than the first imaging dataset. Since the second term of the objective function tends to drive the denoising algorithm towards an identity mapping, the second term may, for example, be weighted with a relatively low weight or may be only applied during every second iteration of the optimization or another subset of the iteration.

For generating the first recombined dataset, the decomposition is, for example, inverted, where, however, instead of the high-frequency dataset of the first imaging dataset, the denoised high-frequency dataset is used.

According to a number of (e.g., several) embodiments, the objective function depends on the deviation of the denoised high-frequency dataset from the high-frequency dataset of the second imaging dataset.

For example, the first term of the objective function depends on or consists of the deviation of the denoised high-frequency dataset from the high-frequency dataset of the second imaging dataset. Consequently, a reduced computational effort may be achieved. It is noted that the high-frequency dataset of the second imaging dataset does in general include noise that is, however, uncorrelated or approximately uncorrelated with the noise of the high-frequency dataset of the first imaging dataset. It is therefore feasible to compute the first term of the objective function based on the denoised high-frequency dataset and the non-denoised high-frequency dataset of the second imaging dataset.

According to a number of (e.g., several) embodiments, the optimization includes, for example, in each of the iterations or during a subset of the iterations, generating a reference high-frequency dataset by applying the denoising algorithm to the high-frequency dataset of the second imaging dataset. The objective function depends on a deviation of the denoised high-frequency dataset from the reference high-frequency dataset.

For example, in a given iteration, the same version of the denoising algorithm with the same parameters is applied to the high-frequency dataset of the first imaging dataset and to the high-frequency dataset of the second imaging dataset.

For example, the first term of the objective function depends on or consists of the deviation of the denoised high-frequency dataset from the reference high-frequency dataset. Consequently, effects of the denoising algorithms are present in both datasets used for computing the first term. In this way, it is avoided that the first term of the objective function indicates a too high deviation than justified, since the deviation may in part origin from a successful denoising.

According to a number of (e.g., several) embodiments (e.g., in each of the iterations or during a subset of the iterations), the objective function depends on a further denoised high-frequency dataset and the high-frequency dataset of the first imaging dataset. The further denoised high-frequency dataset is generated by applying the denoising algorithm to the high-frequency dataset of the second imaging dataset. The trained denoising algorithm is applied to the high-frequency dataset of the second imaging dataset to generate a further final denoised high-frequency dataset.

For example, further denoised high-frequency dataset is the same as the reference high-frequency dataset in the previously discussed embodiments, but they are used for different purposes. While the reference high-frequency dataset is used to compute the first term of the objective function and eventually to generate the final denoised high-frequency dataset, the further denoised high-frequency dataset is used to compute a third term of the objective function and eventually to generate the further final denoised high-frequency dataset.

For example, in a given iteration, the same version of the denoising algorithm with the same parameters is applied to the high-frequency dataset of the first imaging dataset and to the high-frequency dataset of the second imaging dataset.

For example, the third term of the objective function depends on or consists of the deviation of the further denoised high-frequency dataset and the high-frequency dataset of the first imaging dataset. Consequently, the explanations and advantages explained with respect to the final denoised high-frequency dataset and the process to generate the final denoised high-frequency dataset may be carried over analogously to the further final denoised high-frequency dataset and the process to generate the further final denoised high-frequency dataset.

As a consequence, in such embodiments, the final denoised high-frequency dataset and the further final denoised high-frequency dataset are generated by applying the same version of the trained denoising algorithm. This is particularly beneficial for applications where the final denoised high-frequency dataset and the further final denoised high-frequency dataset or the respective recombined imaging datasets are further processed together (e.g., subtracted from each other). By using the same version of the trained denoising algorithm, it may, for example, be achieved that effects or artifacts generated by the denoising algorithms cancel out.

Further embodiments of the computer-implemented method follow analogously.

For example, in some embodiments, the optimization includes (e.g., in each of the iterations or during a subset of the iterations) generating a second recombined dataset based on the low-frequency dataset of the second imaging dataset and the further denoised high-frequency dataset. The objective function (e.g., a fourth term of the objective function) depends on the second recombined dataset and the second imaging dataset (e.g., a deviation of the second recombined dataset from the second imaging dataset).

For example, in some embodiments, the objective function (e.g., the third term of the objective function) depends on a deviation of the further denoised high-frequency dataset from the high-frequency dataset of the first imaging dataset.

For example, in some embodiments, the optimization includes (e.g., in each of the iterations or during a subset of the iterations) generating a further reference high-frequency dataset by applying the denoising algorithm to the high-frequency dataset of the first imaging dataset. The objective function (e.g., the third term of the objective function) depends on a deviation of the further denoised high-frequency dataset from the further reference high-frequency dataset.

According to a number of (e.g., several) embodiments, the objective function depends on a deviation of the denoised high-frequency dataset from the further denoised high-frequency dataset.

For example, a fifth term of the objective function depends on or consists of the deviation of the denoised high-frequency dataset from the further denoised high-frequency dataset. Consequently, a consistent denoising of the high-frequency datasets of the first imaging dataset and the second imaging dataset is achieved.

According to a number of (e.g., several) embodiments, a trainable further denoising algorithm is trained by carrying out a further optimization that uses at least one parameter of the further denoising algorithm as at least one further optimization variable and a further objective function that depends on a further denoised high-frequency dataset and the high-frequency dataset of the second imaging dataset (e.g., a respective deviation). The further denoised high-frequency dataset is generated by applying the further denoising algorithm to the high-frequency dataset of the second imaging dataset. The trained further denoising algorithm is applied to the high-frequency dataset of the second imaging dataset to generate a further final denoised high-frequency dataset.

The further denoising algorithm may in principle be the same as the denoising algorithm, but they are trained independently from each other. The further denoising algorithm may also be different than the denoising algorithm. In other words, the denoising of the high-frequency datasets of the first imaging dataset and the second imaging dataset are computed independently.

According to a number of (e.g., several) embodiments, the first imaging dataset includes a first two-dimensional X-ray image, and/or the second imaging dataset includes a second two-dimensional X-ray image.

According to a number of (e.g., several) embodiments, the first imaging dataset includes a first three-dimensional X-ray-based image reconstruction, and/or the second imaging dataset includes a second three-dimensional X-ray-based image reconstruction.

According to a number of (e.g., several) embodiments, the first imaging parameter set specifies a first energy spectrum, and/or the second imaging parameter set specifies a second energy spectrum that is different than the first energy spectrum.

The first energy spectrum and the second energy spectrum are, for example, energy spectra generated by the X-ray source or detected by the X-ray detector.

A medical imaging technique that utilizes two different energy spectra to acquire images is also referred to as dual energy imaging. This approach enhances the contrast and differentiation of materials within a body, allowing for more detailed and accurate diagnostic information.

Different materials and tissues in the body absorb X-rays differently depending on the energy level. By using two energy spectra, dual energy imaging may differentiate between materials with similar attenuation at one energy level but different attenuation at another. This is particularly useful for distinguishing between bone and soft tissue or identifying specific substances such as iodine or calcium.

According to a number of (e.g., several) embodiments, the decomposition includes a Fourier decomposition of the first imaging dataset and/or a Fourier decomposition of the second imaging dataset.

In this way, fast and reliable Decomposition is achievable. The Fourier decomposition includes, for example, a Fourier transformation of the respective imaging dataset from the image domain into the frequency domain, a separation of the resulting frequency data, and an inverse Fourier transformation of the individual separated parts.

According to a number of (e.g., several) embodiments, the decomposition includes a Laplace decomposition of the first imaging dataset and/or a Laplace decomposition of the second imaging dataset.

The explanations regarding the Fourier decomposition hold analogously, where the Fourier transformation and inverse Fourier transformation are replaced by the Laplace transformation and inverse Laplace transformation, respectively.

According to a number of (e.g., several) embodiments, the decomposition includes a wavelet decomposition of the first imaging dataset and/or a wavelet decomposition of the second imaging dataset.

The explanations regarding the Fourier decomposition hold analogously, where the Fourier transformation and inverse Fourier transformation are replaced by the wavelet transformation and inverse wavelet transformation, respectively.

According to a number of (e.g., several) embodiments, the decomposition includes a spline decomposition of the first imaging dataset and/or a spline decomposition of the second imaging dataset.

The explanations regarding the Fourier decomposition hold analogously, where the Fourier transformation and inverse Fourier transformation are replaced by the spline transformation (e.g., B-spline transformation) and inverse spline transformation (e.g., inverse B-spline transformation), respectively.

According to a number of (e.g., several) embodiments, the two or more spatial frequency bands are predefined.

The overall computational effort is therefore reduced.

According to a number of (e.g., several) embodiments, the decomposition is carried out according to at least one decomposition parameter, and the optimization uses the at least one decomposition parameter as at least one further optimization variable.

For example, the at least one decomposition parameter defines the two or more spatial frequency bands. Consequently, the optimal decomposition (e.g., the optimal choice of frequency bands) is trained individually for the given first imaging dataset and, if applicable, the given second imaging dataset. Therefore, the performance of the denoising may be improved.

According to a number of embodiments, the denoising algorithm includes an artificial neural network, ANN.

For example, that at least one parameter of the denoising algorithm includes a plurality of weighting factors of the ANN in such embodiments. Such embodiments are particularly beneficial, since well-established methods for adapting or updating weighting factors of an ANN (e.g., the backpropagation algorithm) provide a powerful framework for using the ANN in an implicit manner in the computer-implemented method according to the present embodiments.

The ANN may, for example, be or include a deep neural network, a convolutional neural network, or a convolutional deep neural network. Further, the ANN may be or include an adversarial network, a deep adversarial network, and/or a generative adversarial network, GAN.

According to a number of (e.g., several) embodiments, the ANN is or includes a U-Net or is based on a U-Net.

According to a number of (e.g., several) embodiments, the ANN is or includes a Noise2Noise network.

According to a number of (e.g., several) embodiments, the denoising algorithm includes a Gaussian filter and/or a bilateral filter (e.g., a joint bilateral filter or a guided filter).

For example, that at least one parameter of the denoising algorithm may, for example, include a smoothing parameter, also denoted as width or standard deviation in some cases. Consequently, the denoising is particularly simple from a computational point of view. For the more common the number of required iterations in the optimization may be reduced.

According to a further aspect of the present embodiments, a computer-implemented method for material sensitive medical imaging is provided. Therein, a computer-implemented method for denoising medical imaging data according to the present embodiments is carried out. At least one material-specific imaging dataset, including, for example, a virtual non-contrast image and/or a contrast image (e.g., an iodine map) is generated depending on the final denoised high-frequency dataset.

For example, at least one material-specific imaging dataset is generated depending on the recombined first imaging dataset and the recombined second imaging dataset. For example, generating the least one material-specific imaging dataset includes subtracting the recombined first imaging dataset and the recombined second imaging dataset from each other.

According to a further aspect of the present embodiments, a data processing system is provided. The data processing system is configured to carry out a computer-implemented method according to the present embodiments.

For example, the data processing device may include one or more computers, one or more microcontrollers, and/or one or more integrated circuits (e.g., one or more application-specific integrated circuits (ASICs), one or more field-programmable gate arrays (FPGAs), and/or one or more systems on a chip (SoC)). The data processing device may also include one or more processors (e.g., one or more microprocessors, one or more central processing units (CPUs), one or more graphics processing units (GPUs), and/or one or more signal processors, such as one or more digital signal processors (DSPs)). The data processing device may also include a physical or a virtual cluster of computers or other of the units.

In various embodiments, the data processing device includes one or more hardware and/or software interfaces and/or one or more memory units.

A memory unit may be implemented as a volatile data memory (e.g., a dynamic random access memory (DRAM) or a static random access memory (SRAM)) or as a non-volatile data memory (e.g., a read-only memory (ROM), a programmable read-only memory (PROM), an erasable programmable read-only memory (EPROM), an electrically erasable programmable read-only memory (EEPROM), a flash memory or flash EEPROM, a ferroelectric random access memory (FRAM), a magnetoresistive random access memory (MRAM), or a phase-change random access memory (PCRAM)).

According to a further aspect of the present embodiments, a medical imaging system is provided. The medical imaging device includes a data processing system according to the present embodiments and a medical imaging system that is configured to generate the first imaging dataset and the second imaging dataset.

The medical imaging device may, for example, be an X-ray imaging device, a C-arm X-ray imaging device, a CBCT device, a CT device, a photon counting CT device, or an MRI device.

Further embodiments of the medical imaging system according to the present embodiments follow directly from the various embodiments of the computer-implemented methods according to the present embodiments, and vice versa. For example, individual features and corresponding explanations as well as advantages relating to the various implementations of the computer-implemented methods according to the present embodiments may be transferred analogously to corresponding implementations of the medical imaging system according to the present embodiments. For example, the medical imaging system according to the present embodiments is designed or programmed to carry out a computer-implemented method according to the present embodiments. For example, the medical imaging system according to the present embodiments carries out a computer-implemented method according to the present embodiments.

According to a further aspect of the present embodiments, a computer program including instructions is provided. When the instructions are executed by a data processing system, the instructions cause the data processing system to carry out a computer-implemented method according to the present embodiments.

The instructions may be provided as program code, for example. The program code may, for example, be provided as binary code or assembler, and/or as source code of a programming language (e.g., C), and/or as program script (e.g., Python).

According to a further aspect of the present embodiments, a computer-readable storage medium (e.g., a non-transitory computer-readable storage medium) storing a computer program according to the present embodiments is provided.

The computer program and the computer-readable storage medium are respective computer program products including the instructions.

Further features and feature combinations of the invention are obtained from the figures and their description as well as the claims. For example, further implementations of the invention may not necessarily contain all features of one of the claims. Further implementations of the invention may include features or combinations of features that are not recited in the claims.

In the following, the invention will be explained in detail with reference to specific example implementations and respective schematic drawings. In the drawings, same or functionally same elements may be denoted by the same reference signs. The description of same or functionally same elements is not necessarily repeated with respect to different figures.

### BRIEF DESCRIPTION OF THE DRAWINGS

FIG. 1 shows schematically an example embodiment of a medical imaging system;

FIG. 2 shows a schematic flow diagram of an example embodiment of a computer-implemented method for denoising medical imaging data;

FIG. 3 shows a schematic flow diagram of a further example embodiment of a computer-implemented method for denoising medical imaging data;

FIG. 4 shows a schematic flow diagram of a further example embodiment of a computer-implemented method for denoising medical imaging data;

FIG. 5 shows a schematic flow diagram of a further example embodiment of a computer-implemented method for denoising medical imaging data

FIG. 6 shows a schematic flow diagram of a further example embodiment of a computer-implemented method for denoising medical imaging data;

FIG. 7 shows schematically an artificial neural network;

FIG. 8 shows schematically a convolutional neural network; and

FIG. 9 shows schematically a further convolutional neural network.

### DETAILED DESCRIPTION

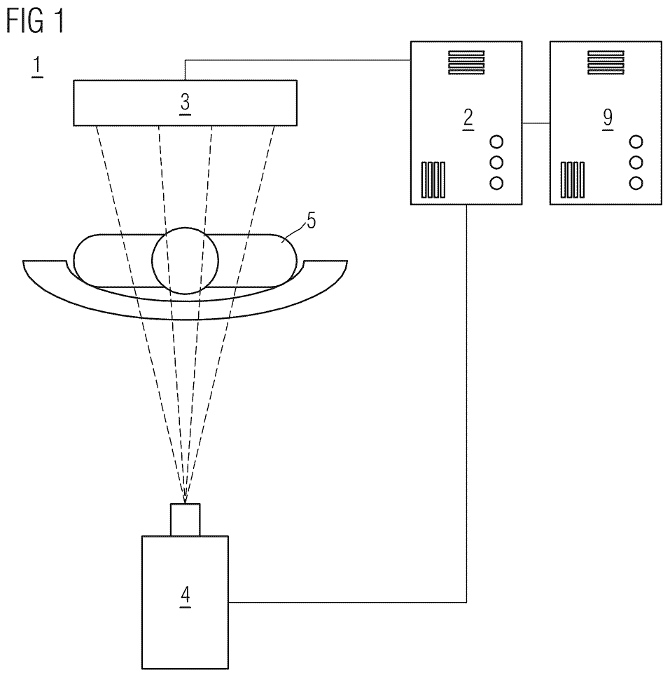

FIG. 1 shows schematically an example embodiment of a medical imaging system 1 that is, for example, implemented as an X-ray imaging system 1. The X-ray imaging system 1 includes a source unit 3 with an X-ray source, a detector unit 4 with an X-ray detector, and a control system 2 that is configured to control the X-ray source and the X-ray detector to generate X-ray images depicting an object 5 (e.g., a patient). The X-ray imaging system 1 is, for example, capable of generating energy generate X-ray images according to different energy domains (e.g., by using different X-ray spectra).

The X-ray imaging system 1 may, for example, include a patient table, on which the object 5 is arranged. The X-ray imaging system 1 further includes a data processing system 9 according to the present embodiments that is configured to carry out a computer-implemented method for denoising medical imaging data according to the present embodiments. In the following, a number of (e.g., several) functions and method acts may be described to be carried out by the control system 2, while other functions and method acts are described to be carried out by the data processing system 9. It is noted that the functions and method acts may also be distributed in different ways in alternative implementations. In some embodiments, the data processing system 9 may include the control system 2 or parts of it.

For example, the control system 7 may adjust various imaging parameters of the X-ray imaging system 1 including, for example, exposure parameters such as a peak kilovoltage of the X-ray source, a tube current of the X-ray source, and/or an X-ray pulse duration. For example, the control system 7 may adjust further imaging parameters such as a filter material and/or filter thickness of an X-ray filter (e.g., a copper filter) by placing the appropriate X-ray filter into the beam path or by removing the X-ray filter from the beam path, respectively. For example, the control system 7 may adjust further imaging parameters such as a collimator opening size of an X-ray collimator. For example, the control system 7 may bring the X-ray collimator into the beam path or by removing the X-ray collimator from the beam path, respectively. For example, the control system 7 may adjust further imaging parameters such as a gain factor of the X-ray detector. For example, the control system 7 may bring an anti-scattering grid into the beam path or by removing the anti-scattering grid from the beam path, respectively.

The X-ray imaging system 1 may also be implemented as a C-arm system, a CBCT system or a CT system, for example.

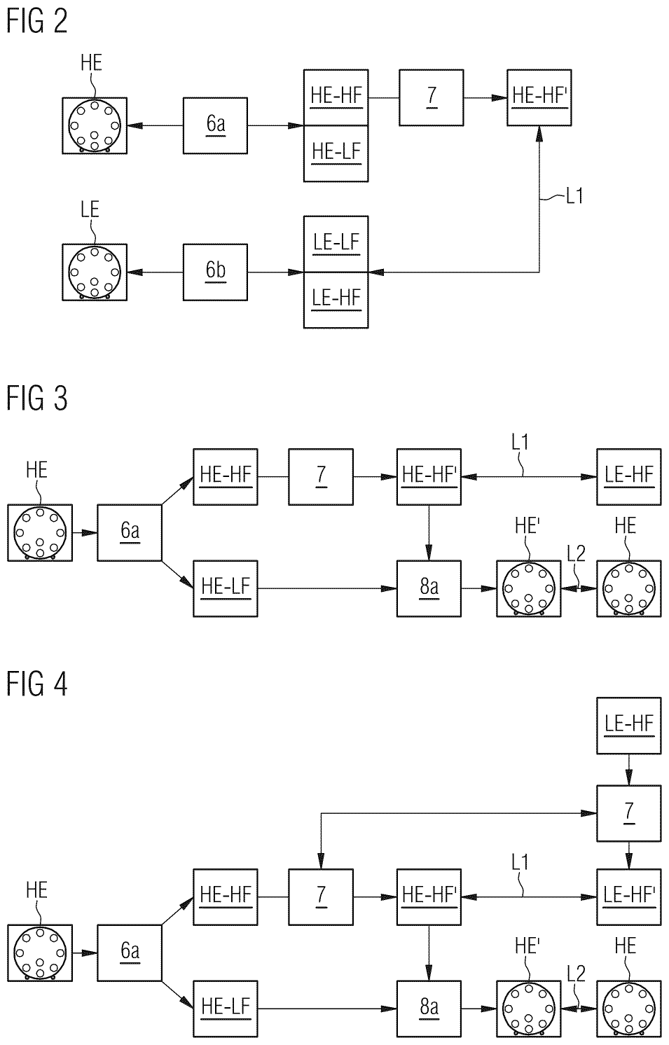

FIG. 2 shows a schematic flow diagram of an example embodiment of a computer-implemented method for denoising medical imaging data according to the present embodiments, which may be carried out, for example, by the data processing system 9 of the medical imaging system one of FIG. 1.

A first imaging dataset HE depicting the object 5 and a second imaging dataset LE generated according to a second imaging parameter set depicting the object 5 are received. The first imaging dataset HE and the second imaging dataset LE are, for example, generated by the X-ray imaging system 1 with different energy spectra being used (e.g., a high energy spectrum for the first imaging dataset HE and a low energy spectrum for the second imaging dataset LE).

The first imaging dataset HE and the second imaging dataset LE may be pre-processed prior to the decomposition. The pre-processing includes, for example, a logarithmic transformation and/or a correction of further physical effects (e.g., beam-hardening or scattering).

The first imaging dataset HE and the second imaging dataset LE are decomposed individually according to two or more spatial frequency bands. The decomposition 6a of the first imaging dataset HE includes generating a high-frequency dataset of the first imaging dataset HE-HF corresponding to a high-frequency band of the two or more spatial frequency bands and a low-frequency dataset of the first imaging dataset HE-LF corresponding to a low-frequency band of the two or more spatial frequency bands. The decomposition 6b of the second imaging dataset LE includes generating a high-frequency dataset of the second imaging dataset LE-HF corresponding to the high-frequency band and a low-frequency dataset of the second imaging dataset LE-LF corresponding to the low-frequency band.

A trainable denoising algorithm 7 is trained by carrying out an optimization that uses at least one parameter of the denoising algorithm 7 as optimization variable and an objective function that includes a first term L1 depending on a denoised high-frequency dataset HE-HF′ and the high-frequency dataset of the second imaging dataset LE-HF. The denoised high-frequency dataset HE-HF′ is generated by applying the denoising algorithm 7 to the high-frequency dataset of the first imaging dataset HE-HF.

The first term L1 of the loss function provides that the correlated high-frequency features such as edges are preserved while the uncorrelated noise is removed or reduced. For example, the denoised high-frequency dataset HE-HF′ and the low-frequency dataset of the first imaging dataset HE-LF may be recombined by inverting the frequency decomposition 6a to yield a recombined first imaging dataset HE′.

The optimization may, for example, be carried out in a number of (e.g., several) iterations until the objective function has converged. The trained denoising algorithm 7 is applied to the high-frequency dataset of the first imaging dataset HE-HF to generate a final denoised high-frequency dataset HE-HF′.

For example, the denoising algorithm 7 may be implemented as an ANN (e.g., a Noise2Noise network). In some embodiments, the ANN may, however, be exchanged with or extended by trainable guided filter or a joint bilateral filter.

Possible methods for the frequency transform used for the decompositions 6a, 6b include but are not limited to a Fourier transform with frequency thresholding, a Laplace transform, a Wavelet transform, a B-spline transform, etc.

In some embodiments, the frequency transform may be performed hierarchically to separate multiple frequency bands. In this way, the terms of the objective function corresponding to different high-frequency bands may be weighted proportional to the frequency.

In some embodiments, the frequency transform may also be included into the training procedure for online calibration of, for example, the frequency thresholds.

In some embodiments, the same method acts may be applied analogously to the second imaging dataset LE.

In some embodiments, during the iterations of the optimization, the high-energy and low-energy data may, for example, be alternately interchanged as inputs and labels to denoise both data simultaneously.

In some embodiments, the effect of the denoising algorithm 7 may be constrained to a physically expected variance of the noise (e.g., using a noise gate).

FIG. 3 shows a schematic flow diagram of a further example embodiment of a computer-implemented method for denoising medical imaging data according to the present embodiments, which is based on the embodiment of FIG. 2.

In this embodiment, the optimization includes generating the first recombined dataset HE′ based on the low-frequency dataset of the first imaging dataset HE-LF and the denoised high-frequency dataset HE-HF′ as indicated by a recombination module 8a. A second term L2 of the objective function depends on the first recombined dataset HE′ and the first imaging dataset HE.

The second term L2 provides that the general image impression and intensity after the denoising is not fundamentally different than the initial data. Suitable losses include content-based or content-sensitive losses, such as VGG-loss, structural similarity index, multiscale structural similarity index, or conventional losses such as the mean-squared error. Since the second term L2 would approximately be optimal for a denoising algorithm 7 learning the identity, the second L2 may, for example, be weighted with a relatively low weight or only applied during, for example, every second iteration of the optimization.

FIG. 4 shows a schematic flow diagram of a further example embodiment of a computer-implemented method for denoising medical imaging data according to the present embodiments, which is based on the embodiment of FIG. 3.

In this embodiment, the optimization includes generating a reference high-frequency dataset LE-HF′ by applying the same denoising algorithm 7 as applied to the high-frequency dataset of the first imaging dataset HE-HF also to the high-frequency dataset of the second imaging dataset LE-HF in each iteration. In other words, the denoising algorithms 7 have shared parameters (e.g., shared weights in case of an ANN). The first term L1 of the objective function then depends on a deviation of the denoised high-frequency dataset HE-HF′ from the reference high-frequency dataset LE-HF′.

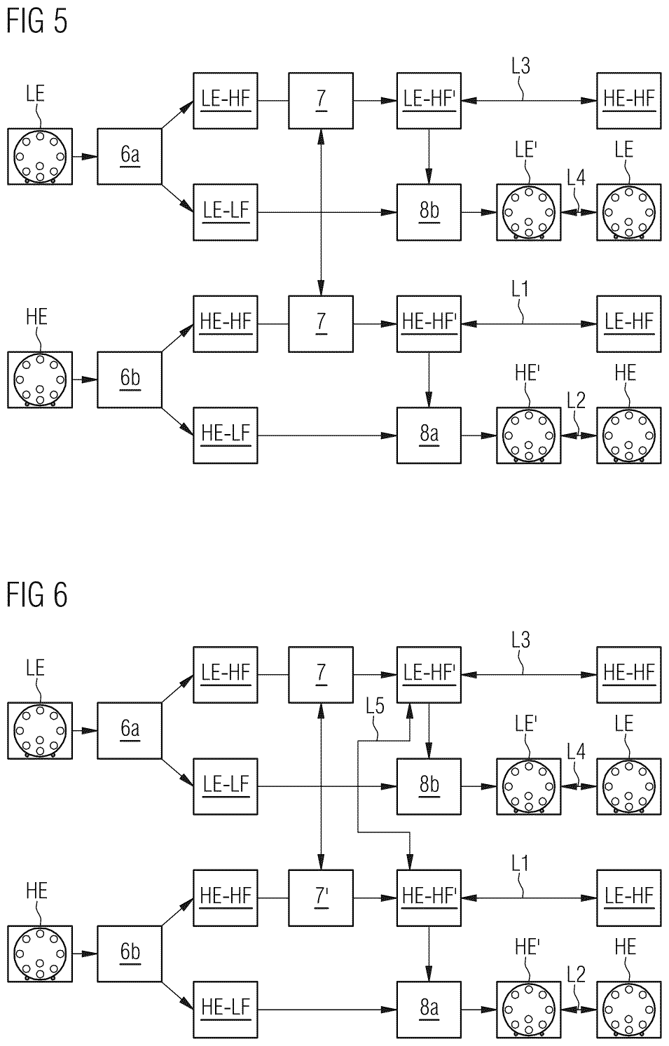

FIG. 5 shows a schematic flow diagram of a further example embodiment of a computer-implemented method for denoising medical imaging data according to the present embodiments, which is based on the embodiment of FIG. 2.

In this embodiment, a third term L3 of the objective function depends on a further denoised high-frequency dataset LE-HF′ and the high-frequency dataset of the first imaging dataset HE-HF. The further denoised high-frequency dataset LE-HF′ is generated by applying the same denoising algorithm 7 as applied to the high-frequency dataset of the first imaging dataset HE-HF also to the high-frequency dataset of the second imaging dataset LE-HF in each iteration. In other words, the denoising algorithms 7 have shared parameters (e.g., shared weights in case of an ANN). The trained denoising algorithm 7 is applied to the high-frequency dataset of the second imaging dataset LE-HF to generate a further final denoised high-frequency dataset LE-HF′.

For example, all energy bins are denoised simultaneously in such embodiments. The illustration of FIG. 5 shows the application to two energy bins (e.g., high-energy and low-energy). However, the method may be applied to any number of energy bins analogously. In case more than two energy bins are considered, the first term L1 may, for example, be computed with respect to all other energy bins in some embodiments.

Optionally, the second term L2 of the objective function may be used additionally as described with respect to FIG. 3.

Also optionally, the optimization may include generating the second recombined dataset LE′ based on the low-frequency dataset of the second imaging dataset LE-LF and the further denoised high-frequency dataset LE-HF′, as indicated by a further recombination module 8b. A fourth term L4 of the objective function depends on the second recombined dataset LE′ and the second imaging dataset LE.

FIG. 6 shows a schematic flow diagram of a further example embodiment of a computer-implemented method for denoising medical imaging data according to the present embodiments, which is based on the embodiment of FIG. 5.

In this embodiment, a fifth term L5 of the objective function depends on a deviation of the denoised high-frequency dataset HE-HF′ from the further denoised high-frequency dataset LE-HF′.

As explained, in particular, with reference to the figures, the improved concept according to the present embodiments allows for an effective denoising without losing potentially relevant details but also without requiring training images and correspondingly annotated ground truth images. For example, the present embodiments effectively utilize a data-specific denoising algorithm.

In some embodiments, an implicit ANN is used to suppress noise but preserve details in spectral X-ray imaging data (e.g., two-dimensional projection images or three-dimensional CT reconstructions). For example, the performance of ANN architectures is exploited without the need of training data. Due to the inherent parallelizability of ANNs, the computational acts may be carried out particularly fast.

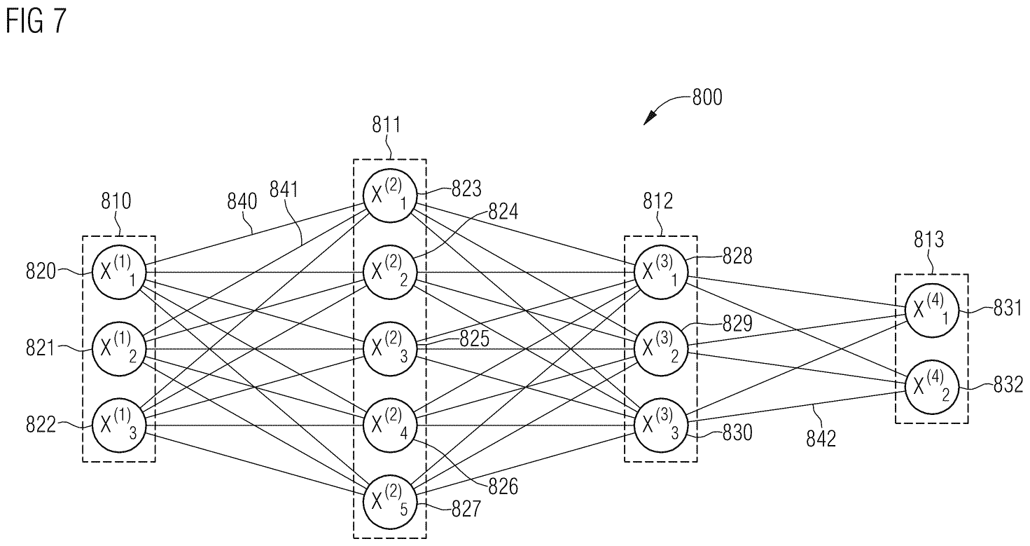

FIG. 7 displays an embodiment of an ANN 800 that is, for example, configured as an MLP. The ANN 800 includes nodes 820, . . . , 832 and edges 840, . . . , 842, where each edge 840, . . . , 842 is a directed connection from a first node 820, . . . , 832 to a second node 820, . . . , 832. In general, the first node 820, . . . , 832 and the second node 820, . . . , 832 are different nodes 820, . . . , 832. It is, however, also possible that the first node 820, . . . , 832 and the second node 820, . . . , 832 are the same. For example, in FIG. 7, the edge 840 is a directed connection from the node 820 to the node 823, and the edge 842 is a directed connection from the node 830 to the node 832. An edge 840, . . . , 842 from a first node 820, . . . , 832 to a second node 820, . . . , 832 is also denoted as ingoing edge for the second node 820, . . . , 832 and as outgoing edge for the first node 820, . . . , 832.

In this example, the nodes 820, . . . , 832 of the artificial neural network 800 may be arranged in layers 810, . . . , 813, where the layers may include an intrinsic order introduced by the edges 840, . . . , 842 between the nodes 820, . . . , 832. For example, edges 840, . . . , 842 may exist only between neighboring layers of nodes. In the displayed example, there is an input layer 810 including only nodes 820, . . . , 822 without an incoming edge, an output layer 813 including only nodes 831, 832 without outgoing edges, and hidden layers 811, 812 inbetween the input layer 810 and the output layer 813. In general, the number of hidden layers 811, 812 may be chosen arbitrarily. In an MLP, this number is at least one. The number of nodes 820, . . . , 822 within the input layer 810 may relate to the number of input values of the artificial neural network 800, and the number of nodes 831, 832 within the output layer 813 may relate to the number of output values of the artificial neural network 800.

For example, a real number may be assigned as a value to every node 820, . . . , 832 of the artificial neural network 800. Here, x⁽ⁿ⁾ᵢ denotes the value of the i-th node 820, . . . , 832 of the n-th layer 810, . . . , 813. The values of the nodes 820, . . . , 822 of the input layer 810 are equivalent to the input values of the artificial neural network 800. The values of the nodes 831, 832 of the output layer 813 are equivalent to the output value of the artificial neural network 800. Further, each edge 840, . . . , 842 may include a weight being a real number. For example, the weight is a real number within the interval [−1, 1] or within the interval [0, 1]. Here, w^{(m,n)}_{i,j} denotes the weight of the edge between the i-th node 820, . . . , 832 of the m-th layer 810, . . . , 813 and the j-th node 820, . . . , 832 of the n-th layer 810, . . . , 813. Further, the abbreviation w⁽ⁿ⁾_{i,j} is defined for the weight w^{(n,n+1)}_{i,j}. For example, to calculate the output values of the neural network 800, the input values are propagated through the neural network 800. For example, the values of the nodes 820, . . . , 832 of the (n+1)-th layer 810, . . . , 813 may be calculated based on the values of the nodes 820, . . . , 832 of the n-th layer 810, . . . , 813 by

$${x}_{j}^{( n + 1 )} = f ( {\sum }_{i} {x}_{i}^{( n )} {w}_{i , j}^{( n )} ) .$$

Herein, the function f is denoted as transfer function or activation function. Known transfer functions are step functions, the sigmoid functions (e.g., the logistic function), the generalized logistic function, the hyperbolic tangent, the arctangent function, the error function, the smoothstep function, or rectifier functions. The transfer function is, for example, used for normalization purposes. For example, the values are propagated layer-wise through the neural network 800, where values of the input layer 810 are given by the input of the neural network 800. Values of the first hidden layer 811 may be calculated based on the values of the input layer 810 of the neural network 800. Values of the second hidden layer 812 may be calculated based on the values of the first hidden layer 811, and so forth.

In order to set the values w^{(m,n)}_{i,j} for the edges, the neural network 800 is to be trained using training data. For example, training data includes training input data and training output data (denoted as tᵢ). For a training step, the neural network 800 is applied to the training input data to generate calculated output data. For example, the training data and the calculated output data include a number of values. The number is equal to the number of nodes of the output layer. For example, a comparison between the calculated output data and the training data is used to recursively adapt the weights within the neural network 800 (e.g., backpropagation algorithm). For example, the weights are changed according to

$${w}_{i , j}^{′ ( n )} = {w}_{i , j}^{( n )} - γ {δ}_{j}^{( n )} {x}_{i}^{( n )} ,$$

where γ is a predefined learning rate, and the numbers δ⁽ⁿ⁾ⱼ may be recursively calculated as

$${δ}_{j}^{( n )} = ( {\sum }_{k} {δ}_{k}^{( n + 1 )} {w}_{j , k}^{( n + 1 )} ) {f}^{′} ( {x}_{i}^{( n )} {w}_{i , j}^{( n )} )$$

based on δ⁽ⁿ⁺¹⁾ⱼ, if the (n+1)-th layer is not the output layer 813, and

$${δ}_{j}^{( n )} = ( {x}_{j}^{( n + 1 )} - {t}_{j}^{( n + 1 )} ) {f}^{′} ( {x}_{i}^{( n )} {w}_{i , j}^{( n )} ) ,$$

if the (n+1)-th layer is the output layer 813. f′ is the first derivative of the activation function, and t⁽ⁿ⁺¹⁾ⱼ is the comparison training value for the j-th node of the output layer 813.

A convolutional neural network, CNN, is an ANN that uses a convolution operation instead of general matrix multiplication in at least one of its layers. These layers are denoted as convolutional layers. For example, a convolutional layer performs a dot product of one or more convolution kernels with the convolutional layer's input data. The entries of the one or more convolution kernel are parameters or weights that may be adapted by training. For example, one may use the Frobenius inner product and the ReLU activation function. A convolutional neural network may include additional layers (e.g., pooling layers, fully connected layers, and/or normalization layers).

By using convolutional neural networks, the input may be processed in a very efficient way because a convolution operation based on different kernels may extract various image features so that by adapting the weights of the convolution kernel, the relevant image features may be found during training. Further, based on the weight-sharing in the convolutional kernels, fewer parameters are to be trained, which prevents overfitting in the training phase and allows to have faster training or more layers in the network, improving the performance of the network.

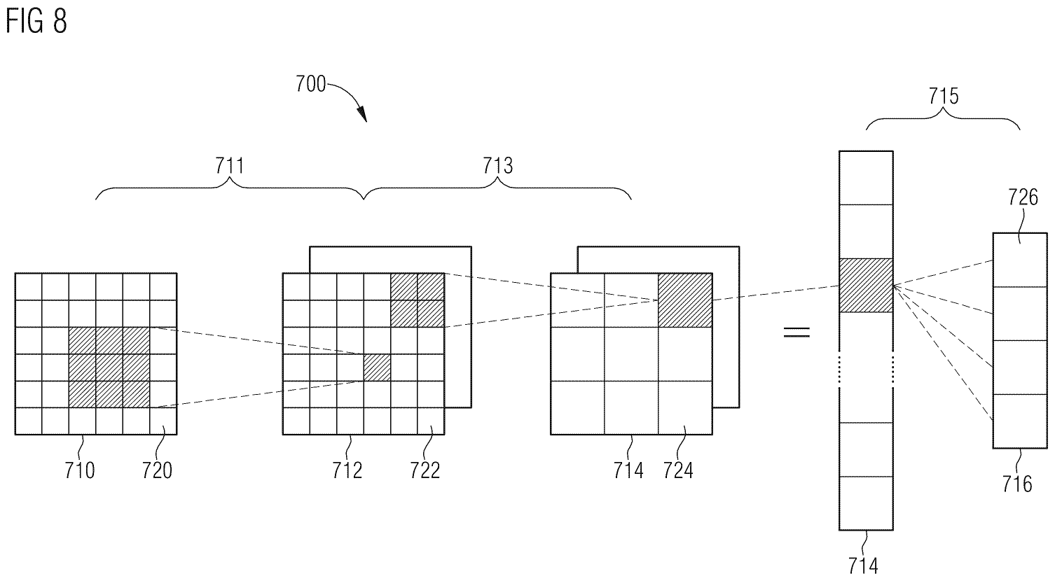

FIG. 8 displays an example embodiment of a convolutional neural network 700. In the displayed embodiment, the convolutional neural network 700 includes an input node layer 710, a convolutional layer 711, a pooling layer 713, a fully connected layer 714, and an output node layer 716, as well as hidden node layers 712, 714. Alternatively, the convolutional neural network 200 may include a number of (e.g., several) convolutional layers 711, a number of (e.g., several) pooling layers 713, and/or a number of (e.g., several) fully connected layers 715, as well as other types of layers. The order of the layers may be chosen arbitrarily, usually fully connected layers 715 are used as the last layers before the output layer 716.

For example, within a convolutional neural network 700, nodes 720, 722, 724 of a node layer 710, 712, 714 may be considered to be arranged as a d-dimensional matrix or as a d-dimensional image. For example, in the two-dimensional case, the value of the node 720, 722, 724 indexed with i and j in the n-th node layer 710, 712, 714 may be denoted as x(n)[i, j]. However, the arrangement of the nodes 720, 722, 724 of one node layer 710, 712, 714 does not have an effect on the calculations executed within the convolutional neural network 700 as such, since these are given solely by the structure and the weights of the edges.

A convolutional layer 711 is a connection layer between an anterior node layer 710 with node values x(n−1) and a posterior node layer 712 with node values x(n). For example, a convolutional layer 711 is characterized by the structure and the weights of the incoming edges forming a convolution operation based on a certain number of kernels. For example, the structure and the weights of the edges of the convolutional layer 711 are chosen such that the values x(n) of the nodes 722 of the posterior node layer 712 are calculated as a convolution x(n)=K*x(n−1) based on the values x(n−1) of the nodes 720 anterior node layer 710, where the convolution * is defined in the two-dimensional case as

$${x}^{( n )} [ i , j ] = ( K * {x}^{( n - 1 )} ) [ i , j ] = {\sum }_{{i}^{′}} {\sum }_{{j}^{′}} K [ {i}^{′} , {j}^{′} ] \cdot {x}^{( n - 1 )} [ i - {i}^{′} , j - {j}^{′} ] .$$

Herein, the kernel K is a d-dimensional matrix (e.g., in the present example, a two-dimensional matrix), which may be small compared to the number of nodes 720, 722 (e.g., a 3×3 matrix or a 5×5 matrix). For example, this implies that the weights of the edges in the convolution layer 711 are not independent, but chosen such that the weights produce the convolution equation. For example, for a kernel being a 3×3 matrix, there are only 9 independent weights. Each entry of the kernel matrix corresponds to one independent weight, irrespectively of the number of nodes 720, 722 in the anterior node layer 710 and the posterior node layer 712.

In general, convolutional neural networks 700 use node layers 710, 712, 714 with a plurality of channels (e.g., due to the use of a plurality of kernels in convolutional layers 711). In those cases, the node layers may be considered as (d+1)-dimensional matrices, the first dimension indexing the channels. The action of a convolutional layer 711 is then in a two-dimensional example defined as

$${x}_{b}^{( n )} [ i , j ] = {\sum }_{a} ( {K}_{a , b} * {x}_{a}^{( n - 1 )} [ i , j ] = {\sum }_{a} {\sum }_{{i}^{′}} {\sum }_{{j}^{′}} {K}_{a , b} [ {i}^{′} , {j}^{′} ] \cdot {x}_{a}^{( n - 1 )} [ i - {i}^{′} , j - {j}^{′} ] ,$$

where

$${x}_{a}^{( n )}$$

corresponds to the a-th channel of the anterior node layer 710,

$${x}_{b}^{( n )}$$

corresponds to the b-th channel of the posterior node layer 712, and K_{a,b} corresponds to one of the kernels. If a convolutional layer 711 acts on an anterior node layer 710 with A channels and outputs a posterior node layer 712 with B channels, there are A·B independent d-dimensional kernels K_{a,b}.

In general, in convolutional neural networks 700, activation functions may be used. In this embodiment, rectified linear unit (ReLU) is used, with R(z)=max(0, z), so that the action of the convolutional layer 711 in the two-dimensional example is

$${x}_{b}^{( n )} [ i , j ] = R ( {\sum }_{a} ( {K}_{a , b} * {x}_{a}^{( n - 1 )} [ i , j ] ) = R ( {\sum }_{a} {\sum }_{{i}^{′}} {\sum }_{{j}^{′}} {K}_{a , b} [ {i}^{′} , {j}^{′} ] \cdot {x}_{a}^{( n - 1 )} [ i - {i}^{′} , j - {j}^{′} ] ) .$$

It is also possible to use other activation functions (e.g., exponential linear unit (ELU), LeakyReLU, Sigmoid, Tanh, or Softmax).

In the displayed embodiment, the input layer 710 includes 36 nodes 720, arranged as a two-dimensional 6×6 matrix. The first hidden node layer 712 includes 72 nodes 722, arranged as two two-dimensional 6×6 matrices, each of the two matrices being the result of a convolution of the values of the input layer with a 3×3 kernel within the convolutional layer 711. Equivalently, the nodes 722 of the first hidden node layer 712 may be interpreted as arranged as a three-dimensional 2×6×6 matrix, where the first dimension correspond to the channel dimension.

An advantage of using convolutional layers 711 is that spatially local correlation of the input data may be exploited by enforcing a local connectivity pattern between nodes of adjacent layers (e.g., by each node being connected to only a small region of the nodes of the preceding layer).

A pooling layer 713 is a connection layer between an anterior node layer 712 with node values x(n−1) and a posterior node layer 714 with node values x(n). For example, a pooling layer 713 may be characterized by the structure and the weights of the edges and the activation function forming a pooling operation based on a non-linear pooling function f. For example, in the two-dimensional case, the values x(n) of the nodes 724 of the posterior node layer 714 may be calculated based on the values x(n−1) of the nodes 722 of the anterior node layer 712 as

$${x}_{b}^{( n )} [ i , j ] = f ( {x}_{b}^{( n - 1 )} [ {id}_{1} , {jd}_{2} ] , … , {x}_{b}^{( n - 1 )} [ ( i + 1 ) {d}_{1} - 1 , Q + 1 ) {d}_{2} - 1 ] ) .$$

In other words, by using a pooling layer 713, the number of nodes 722, 724 may be reduced by replacing a number d1·d2 of neighboring nodes 722 in the anterior node layer 712 with a single node 722 in the posterior node layer 714 being calculated as a function of the values of the number of neighboring nodes. For example, the pooling function f may be the max-function, the average or the L2-Norm. For example, for a pooling layer 713, the weights of the incoming edges are fixed and are not modified by training.

The advantage of using a pooling layer 713 is that the number of nodes 722, 724 and the number of parameters is reduced. This leads to the amount of computation in the network being reduced and to a control of overfitting.

In the displayed embodiment, the pooling layer 713 is a max-pooling layer, replacing four neighboring nodes with only one node. The value is the maximum of the values of the four neighboring nodes. The max-pooling is applied to each d-dimensional matrix of the previous layer. In this embodiment, the max-pooling is applied to each of the two two-dimensional matrices, reducing the number of nodes from 72 to 18.

In general, the last layers of a convolutional neural network 700 may be fully connected layers 715. A fully connected layer 715 is a connection layer between an anterior node layer 714 and a posterior node layer 716. A fully connected layer 713 may be characterized by the fact that a majority (e.g., all) edges between nodes 714 of the anterior node layer 714 and the nodes 716 of the posterior node layer are present. The weight of each of these edges may be adjusted individually.

In this embodiment, the nodes 724 of the anterior node layer 714 of the fully connected layer 715 are displayed both as two-dimensional matrices, and additionally as non-related nodes, indicated as a line of nodes, where the number of nodes was reduced for a better presentability. This operation is also denoted as flattening. In this embodiment, the number of nodes 726 in the posterior node layer 716 of the fully connected layer 715 smaller than the number of nodes 724 in the anterior node layer 714. Alternatively, the number of nodes 726 may be equal or larger.

Further, in this embodiment, the Softmax activation function is used within the fully connected layer 715. By applying the Softmax function, the sum the values of all nodes 726 of the output layer 716 is 1, and all values of all nodes 726 of the output layer 716 are real numbers between 0 and 1. For example, if using the convolutional neural network 700 for categorizing input data, the values of the output layer 716 may be interpreted as the probability of the input data falling into one of the different categories.

For example, convolutional neural networks 700 may be trained based on the backpropagation algorithm. For preventing overfitting, methods of regularization may be used (e.g., dropout of nodes 720, . . . , 724, stochastic pooling, use of artificial data, weight decay based on the L1 or the L2 norm, or max norm constraints).

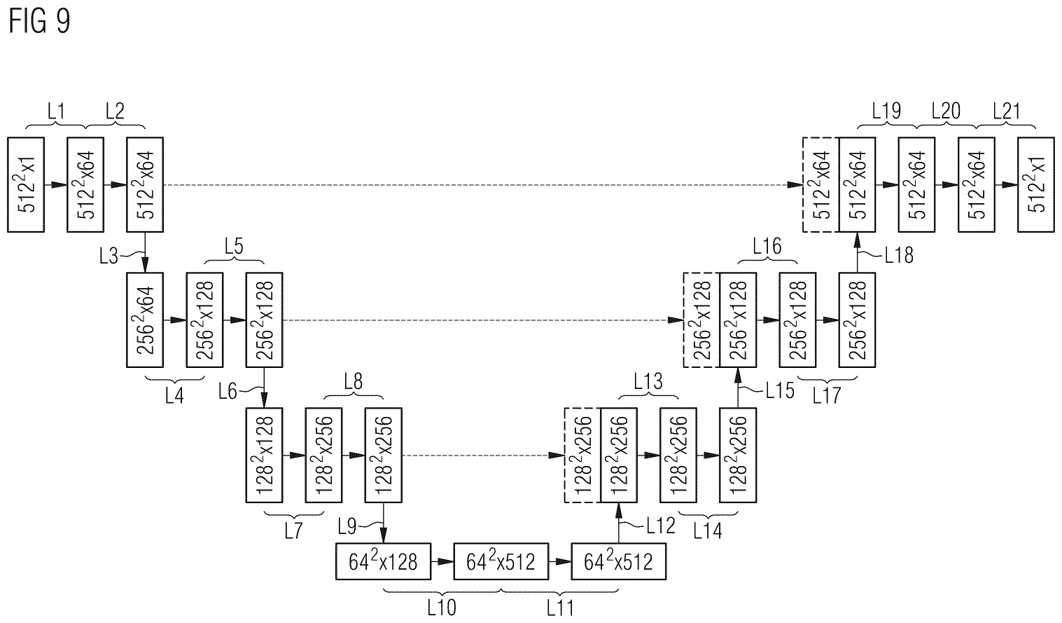

In the example of FIG. 9, the MLM is a CNN (e.g., a convolutional neural network having a U-Net structure). In the displayed example, the input data to the CNN is a two-dimensional medical image including 512×512 pixels, every pixel including one intensity value. The CNN includes convolutional layers indicated by solid, horizontal arrows, pooling layers indicated by solid arrows pointing down, and upsampling layers indicated by solid arrows pointing up. The number of the respective nodes is indicated within the boxes. Within the U-Net structure, first, the input images are downsampled (e.g., by decreasing the size of the images and increasing the number of channels). Afterwards, the input images are upsampled (e.g., by increasing the size of the images and decreasing the number of channels) to generate a transformed image.

All except the last convolutional layers L1, L2, L4, L5, L.7, L8, L10, L11, L13, L14, L16, L17, L19, L20 use 3×3 kernels with a padding of 1, the ReLU activation function, and a number of filters or convolutional kernels that matches the number of channels of the respective node layers as indicated in FIG. 9. The last convolutional layer uses a 1×1 kernel with no padding and the ReLU activation function.

The pooling layers L3, L6, L9 are max-pooling layers, replacing four neighboring nodes with only one node. The value is the maximum of the values of the four neighboring nodes. The upsampling layers L12, L15, L18 are transposed convolution layers with 3×3 kernels and stride 2, which effectively quadruple the number of nodes. The dashed horizontal arrows correspond to concatenation operations, where the output of a convolutional layer L2, L5, L8 of the downsampling branch of the U-Net structure is used as additional inputs for a convolutional layer L13, L16, L19 of the upsampling branch of the U-Net structure. This additional input data is treated as additional channels in the input node layer for the convolutional layer L13, L16, L19 of the upsampling branch.

For training the CNN, a database of 500 first medical images was used. The respective segmentation mask was created based on annotations of expert radiologists. For example, the experts determined for each of the 500 first medical images a segmentation mask for a structure of interest, where a value of 1 was assigned to pixels corresponding to the structure of interest, and a value of 0 was assigned to pixels not corresponding to the structure of interest. The database was split into training data (e.g., 320 datasets), validation data (e.g., 80 datasets), and test data (e.g., 100 datasets). For training the CNN, the backpropagation algorithm was used based on a binary cross-entropy cost function

$$L ( x , y ) = {\sum }_{i} {\sum }_{j} B C E ( y [ i , j ] , M ( x ) [ i , j ] )$$

with

$$B C E ( a , b ) := - a log ( b ) ( b ) - ( 1 - a ) log ( 1 - b ) ,$$

where x denotes a first medical image, y determines the corresponding segmentation mask created by the expert radiologist, and M(x) denotes the result of applying the CNN to the first input medical image x. Alternatively, other cost functions, such as weighted binary cross entropy, Focal Loss, or Dice Loss, may be used.

Based on the validation set of 80 datasets and the corresponding annotations, the best performing machine learning model out of a number of (e.g., several) machine learning models (e.g., with different hyperparameters, such as number of layers, size, and number of kernels, padding, etc.) was selected. The specificity and the sensitivity were determined based on the test set including 100 datasets and the corresponding annotations.

Independent of the grammatical term usage, individuals with male, female, or other gender identities are included within the term.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various

embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for denoising medical imaging data, the computer-implemented method comprising:
receiving a first imaging dataset generated according to a first imaging parameter set and depicting an object, and a second imaging dataset generated according to a second imaging parameter set depicting the object;
decomposing the first imaging dataset and the second imaging dataset according to two or more spatial frequency bands, the decomposing comprising generating a high-frequency dataset of the first imaging dataset and a high-frequency dataset of the second imaging dataset corresponding to a high-frequency band of the two or more spatial frequency bands, and a low-frequency dataset of the first imaging dataset and a low-frequency dataset of the second imaging dataset corresponding to a low-frequency band of the two or more spatial frequency bands;
training a trainable denoising algorithm, the training comprising carrying out an optimization that uses at least one parameter of the denoising algorithm as an optimization variable and an objective function that depends on a denoised high-frequency dataset and the high-frequency dataset of the second imaging dataset, wherein the denoised high-frequency dataset is generated by applying the denoising algorithm to the high-frequency dataset of the first imaging dataset; and
applying the trained denoising algorithm to the high-frequency dataset of the first imaging dataset, such that a final denoised high-frequency dataset is generated.

2. The computer-implemented method of claim 1, wherein the optimization comprises generating a first recombined dataset based on the low-frequency dataset of the first imaging dataset and the denoised high-frequency dataset, and
wherein the objective function depends on the first recombined dataset and the first imaging dataset.

3. The computer-implemented method of claim 1, wherein the objective function depends on a deviation of the denoised high-frequency dataset from the high-frequency dataset of the second imaging dataset.

4. The computer-implemented method of claim 1, wherein the optimization comprises generating a reference high-frequency dataset, the generating of the reference high-frequency dataset comprising applying the denoising algorithm to the high-frequency dataset of the second imaging dataset, and
wherein the objective function depends on a deviation of the denoised high-frequency dataset from the reference high-frequency dataset.

5. The computer-implemented method of claim 1, wherein the objective function depends on a further denoised high-frequency dataset and the high-frequency dataset of the first imaging dataset,
wherein the further denoised high-frequency dataset is generated by applying the denoising algorithm to the high-frequency dataset of the second imaging dataset, and
wherein the trained denoising algorithm is applied to the high-frequency dataset of the second imaging dataset, such that a further final denoised high-frequency dataset is generated.

6. The computer-implemented method of claim 5, wherein the objective function depends on a deviation of the denoised high-frequency dataset from the further denoised high-frequency dataset.

7. The computer-implemented method of claim 1, further comprising:
training a trainable further denoising algorithm, the training of the trainable further denoising algorithm comprising carrying out a further optimization that uses at least one parameter of the further denoising algorithm as a further optimization variable and a further objective function that depends on a further denoised high-frequency dataset and the high-frequency dataset of the second imaging dataset, wherein the further denoised high-frequency dataset is generated by applying the further denoising algorithm to the high-frequency dataset of the second imaging dataset; and
applying the trained further denoising algorithm to the high-frequency dataset of the second imaging dataset, such that a further final denoised high-frequency dataset is generated.

8. The computer-implemented method of claim 1, wherein:
the first imaging dataset comprises a first two-dimensional X-ray image, the second imaging dataset comprises a second two-dimensional X-ray image, or a combination thereof; or
the first imaging dataset comprises a first three-dimensional X-ray-based image reconstruction, the second imaging dataset comprises a second three-dimensional X-ray-based image reconstruction, or a combination thereof.

9. The computer-implemented method of claim 8, wherein the first imaging parameter set specifies a first energy spectrum, the second imaging parameter set specifies a second energy spectrum, or a combination thereof.

10. The computer-implemented method of claim 1, wherein the decomposing comprises:
a Fourier decomposition of the first imaging dataset, a Fourier decomposition of the second imaging dataset, or a combination thereof;
a wavelet decomposition of the first imaging dataset, a wavelet decomposition of the second imaging dataset, or a combination thereof;
a Laplace decomposition of the first imaging dataset, a Laplace decomposition of the second imaging dataset, or a combination thereof; or
a Spline decomposition of the first imaging dataset, a Spline decomposition of the second imaging dataset, or a combination thereof.

11. The computer-implemented method of claim 1, wherein the decomposing is carried out according to at least one decomposition parameter, and the optimization uses the at least one decomposition parameter as a further optimization variable.

12. The computer-implemented method of claim 1, wherein the denoising algorithm comprises an artificial neural network.

13. The computer-implemented method of claim 1, wherein the denoising algorithm comprises a Gaussian filter, a bilateral filter, a guided filter, or any combination thereof.

14. A data processing system comprising:
a processor configured to denoise medical imaging data, the processor being configured to denoise the medical imaging data comprising the processor being configured to:
receive a first imaging dataset generated according to a first imaging parameter set and depicting an object, and a second imaging dataset generated according to a second imaging parameter set depicting the object;
decompose the first imaging dataset and the second imaging dataset according to two or more spatial frequency bands, the decomposition comprising generation of a high-frequency dataset of the first imaging dataset and a high-frequency dataset of the second imaging dataset corresponding to a high-frequency band of the two or more spatial frequency bands, and a low-frequency dataset of the first imaging dataset and a low-frequency dataset of the second imaging dataset corresponding to a low-frequency band of the two or more spatial frequency bands;
train a trainable denoising algorithm, the processor being configured to train the trainable denoising algorithm comprising the processor being configured to carry out an optimization that uses at least one parameter of the denoising algorithm as an optimization variable and an objective function that depends on a denoised high-frequency dataset and the high-frequency dataset of the second imaging dataset, wherein the denoised high-frequency dataset is generated by application of the denoising algorithm to the high-frequency dataset of the first imaging dataset; and
apply the trained denoising algorithm to the high-frequency dataset of the first imaging dataset, such that a final denoised high-frequency dataset is generated.

15. In a non-transitory computer-readable storage medium that stores instructions executable by one or more processors to denoise medical imaging data, the instructions comprising:
receiving a first imaging dataset generated according to a first imaging parameter set and depicting an object, and a second imaging dataset generated according to a second imaging parameter set depicting the object;
decomposing the first imaging dataset and the second imaging dataset according to two or more spatial frequency bands, the decomposing comprising generating a high-frequency dataset of the first imaging dataset and a high-frequency dataset of the second imaging dataset corresponding to a high-frequency band of the two or more spatial frequency bands, and a low-frequency dataset of the first imaging dataset and a low-frequency dataset of the second imaging dataset corresponding to a low-frequency band of the two or more spatial frequency bands;
training a trainable denoising algorithm, the training comprising carrying out an optimization that uses at least one parameter of the denoising algorithm as an optimization variable and an objective function that depends on a denoised high-frequency dataset and the high-frequency dataset of the second imaging dataset, wherein the denoised high-frequency dataset is generated by applying the denoising algorithm to the high-frequency dataset of the first imaging dataset; and
applying the trained denoising algorithm to the high-frequency dataset of the first imaging dataset, such that a final denoised high-frequency dataset is generated.

16. The non-transitory computer-readable storage medium of claim 15, wherein the optimization comprises generating a first recombined dataset based on the low-frequency dataset of the first imaging dataset and the denoised high-frequency dataset, and
wherein the objective function depends on the first recombined dataset and the first imaging dataset.

17. The non-transitory computer-readable storage medium of claim 15, wherein the objective function depends on a deviation of the denoised high-frequency dataset from the high-frequency dataset of the second imaging dataset.

18. The non-transitory computer-readable storage medium of claim 15, wherein the optimization comprises generating a reference high-frequency dataset, the generating of the reference high-frequency dataset comprising applying the denoising algorithm to the high-frequency dataset of the second imaging dataset, and
wherein the objective function depends on a deviation of the denoised high-frequency dataset from the reference high-frequency dataset.

19. The non-transitory computer-readable storage medium of claim 15, wherein the objective function depends on a further denoised high-frequency dataset and the high-frequency dataset of the first imaging dataset,
wherein the further denoised high-frequency dataset is generated by applying the denoising algorithm to the high-frequency dataset of the second imaging dataset, and
wherein the trained denoising algorithm is applied to the high-frequency dataset of the second imaging dataset, such that a further final denoised high-frequency dataset is generated.
